(19) United States
(12) Patent Application Publication
(10) Pub. No.: US 2013/0127598 A1
(43) Pub. Date: May 23, 2013

(54) COMMUNICATION CONTROL METHOD FOR RFID READER

(71) Applicants: Hee-Kyung Kim, Changwon-city (KR); Jae-Won Choi, Changwon-city (KR)

(72) Inventors: Hee-Kyung Kim, Changwon-city (KR); Jae-Won Choi, Changwon-city (KR)

(73) Assignee: SAMSUNG TECHWIN CO., LTD., Changwon-city (KR)

(21) Appl. No.: 13/813,030

(22) PCT Filed: Mar. 2, 2011
(86) PCT No.: PCT/KR2011/001411

§ 371 Date: Feb. 6, 2013

(30) Foreign Application Priority Data
Jul. 29, 2010 (KR) 10-2010-0073538

(51) Int. Cl. G06K 7/01

(52) U.S. Cl. CPC G06K 7/01
USPC 340/10.2

(57) ABSTRACT

Provided is a communication control method for a radio-frequency identification (RFID) reader, which communicates with a plurality of RFID tags, the communication control method including: (a) setting a session in which the RFID tags are initialized after a persistence time; (b) communicating with the RFID tags during the persistence time of the RFID tags; and (c) terminating communications during a set delay time after the persistence time of the RFID tags is over.

### CROSS-REFERENCE TO RELATED PATENT APPLICATION

This application claims priority from Korean Patent Application No. 10-2010-0073538, filed on Jul. 29, 2010, in the Korean Intellectual Property Office, the disclosure of which is incorporated herein in its entirety by reference.

### BACKGROUND

1. Field

Methods consistent with exemplary embodiments of the inventive concept relate to a communication control method for a radio-frequency identification (RFID) reader, and more particularly, to a communication control method for communication by a RFID reader with a plurality of RFID tags.

2. Description of the Related Art

In an RFID system, each RFID reader communicates with a plurality of RFID tags, receives tag information from the plurality of RFID tags, and transmits the received tag information to a server.

Here, each of the RFID readers performs unitary communication. A unitary communication refers to transmitting query command to a plurality of RFID tags and receiving tag information of a RFID in response to one of the query command.

In the unitary communication, if a plurality of RFID tags simultaneously respond to an RFID reader, a reception conflict may occur, and thus, a communication time may increase.

### SUMMARY

One or more exemplary embodiments provide a communication control method for an RFID reader for effectively decreasing a possibility of a communication conflict.

According to an aspect of an exemplary embodiment, there is provided a communication control method for an RFID reader, which communicates with a plurality of RFID tags, the communication control method including operations (a) through (c).

In operation (a), a session in which the RFID tags are initialized after a persistence time is set.

In operation (b), communication is performed with the RFID tags during the persistence time of the RFID tags.

In operation (c), communications is terminated during a set delay time after the persistence time of the RFID tags is over.

### BRIEF DESCRIPTION OF THE DRAWINGS

The exemplary embodiments will become more apparent with reference to the attached drawings, in which:

FIG. 1 is a diagram showing an RFID system in which each of a plurality of RFID readers employing a communication control method according to an exemplary embodiment receives tag information from a plurality of RFID tags and transmit the received tag information to a server via a communication network;

FIG. 2 is a diagram showing an internal configuration of one of the RFID readers of FIG. 1, according to an exemplary embodiment;

FIG. 3 is a diagram showing the internal configuration of a control unit of FIG. 2, according to an exemplary embodiment;

FIG. 4 illustrates persistence times of the RFID tags of FIG. 1 with respect to communication periods and communication termination periods of an RFID reader in each session, according to an exemplary embodiment;

FIG. 5 illustrates communication periods and communication termination periods in the case of applying session 1 as a communication method of the RFID reader of FIG. 1 employing a communication control method according to an exemplary embodiment;

FIG. 6 illustrates communication periods and communication termination periods in the case of applying session 2 or session 3 as a communication method of the RFID reader of FIG. 1 employing a communication control method according to an exemplary embodiment;

FIG. 7 is a flowchart showing a communication control method performed by a communication control unit of FIG. 3, according to an exemplary embodiment;

FIG. 8 is a flowchart showing operation S704 of FIG. 7 in detail, according to an exemplary embodiment;

FIG. 9 is a diagram for describing operation S702 of FIG. 7, according to an exemplary embodiment;

FIG. 10 is a diagram showing an example of methods of calculating a persistence time shown in FIG. 9 in the case where session 1 is applied to the RFID reader of FIG. 1, according to an exemplary embodiment;

FIG. 11 is a flowchart showing details of operation S702 in the case where session 1 is applied to the RFID reader of FIG. 1, according to an exemplary embodiment;

FIG. 12 is a diagram showing an example of operation S702 in the case of applying any of sessions 1 through 3 to the RFID reader of FIG. 1, according to an exemplary embodiment;

FIG. 13 is a diagram showing operation S121 of FIG. 12 in detail, according to an exemplary embodiment; and

FIG. 14 is a diagram showing another example of operation S702 in the case of applying any of sessions 1 through 3 to the RFID reader of FIG. 1, according to an exemplary embodiment.

### DETAILED DESCRIPTION OF THE EXEMPLARY EMBODIMENTS

The inventive concept will now be described more fully with reference to the accompanying drawings, in which exemplary embodiments of the inventive concept are shown. The inventive concept may, however, be embodied in many different forms and should not be construed as being limited to the embodiments set forth herein; rather, these embodiments are provided so that this disclosure will be thorough and complete, and will fully convey the inventive concept to those skilled in the art.

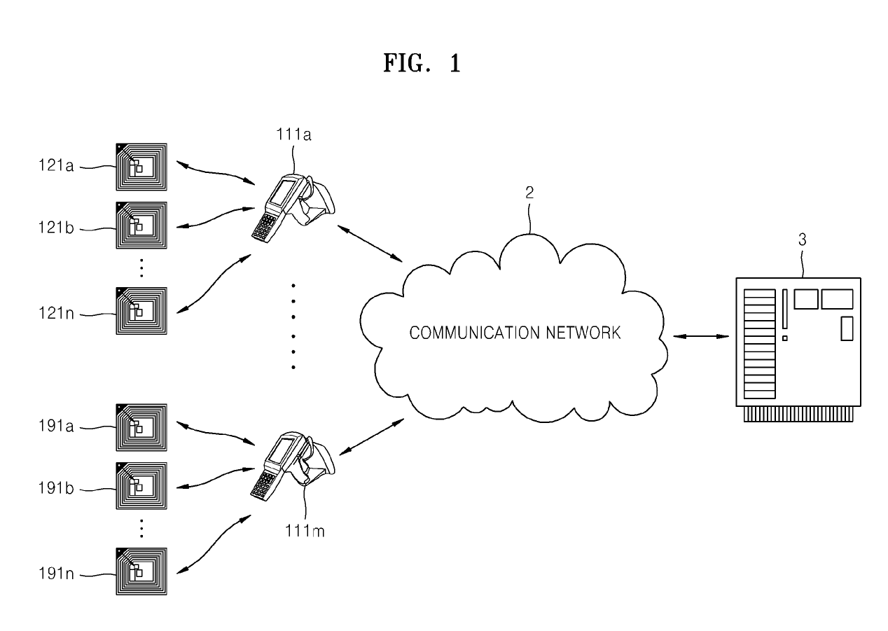

FIG. 1 is a diagram showing an RFID system in which each of a plurality of RFID readers 111a through 111m employing a communication control method according to an exemplary embodiment receives tag information from a plurality of RFID tags 121a through 121n and 191a through 191n and transmit the received tag information to a server 3 via a communication network 2.

Here, each of the RFID readers 111a through 111m successively performs unitary communications. A unitary communication refers to transmitting a query command, for example, from an RFID reader 111a to the plurality of RFID tags 121a through 121n and receiving tag information of an RFID tag in response to the query command, e.g., an Electronic Product Code (EPC).

In the RFID system of FIG. 1, if the plurality of RFID tags 121a through 121n simultaneously respond to an RFID reader 111a, a reception conflict may occur, and thus, a communication time may increase. To reduce a possibility of such conflict, each RFID tag may uses a first target value (generally A) and a second target value (generally B).

In detail, if the RFID reader 111a sets one of sessions 1 through 3 as a communication session, after the RFID tags 121a through 121n are initialized after a persistence time, the initialized RFID tags are set to the first target value at the beginning of a next persistence time. Here, if the RFID reader 111a transmits a query command of the first target value to the RFID tags, one of the RFID tags set to the first target value accurately communicates with the RFID reader and the target value of the corresponding RFID tag is set to a second target value.

Therefore, if the RFID reader 111a continuously uses a query command of the first target value, the number of RFID tags to be communicated is temporarily decreased, and thus, a possibility of a communication conflict may be decreased.

However, as stated above, if the RFID tags are initialized after a corresponding persistence time, the initialized RFID tags are set to the first target value at the beginning of a corresponding next persistence time.

Therefore, even if the RFID reader 111a continuously uses a query command of the first target value, the number of RFID tags to be communicated is temporarily decreased but increases again, and thus, a possibility of a communication conflict is not decreased throughout the whole communication time.

Meanwhile, if the RFID reader 111a sets up session 0 as a communication session, a persistence time of the RFID tags is identical to a period of time during which the RFID reader 111a outputs a power signal, that is, a communication time. In other words, a persistence time of the RFID tags is subordinate to a communication time of an RFID reader. Therefore, a communication period of the RFID reader cannot be set up, and there is inefficient communication.

According to an exemplary embodiment, each of the RFID readers 111a through 111 m applies a session, in which the RFID tags 121a through 121n and 191a through 191n are initialized after a persistence time. In other words, any of sessions 1 through 3 is applied. Session 0 is not used in the present embodiment.

As one of the RFID readers 111a through 111m transmits a query command set to the first target value (generally A) to the RFID tags 121a through 121n and 191a through 191n, one of the RFID tags set to the first target value accurately communicates with the RFID reader and the target value of the corresponding RFID tag is set to the second target value (generally B).

Furthermore, as one of the RFID readers 111a through 111m transmits a query command set to the second target value (generally B) to the RFID tags 121a through 121n and 191a through 191n, one of the RFID tags set to the second target value accurately communicates with the RFID reader and the target value of the corresponding RFID tag is set to the first target value.

After the RFID tags 121a through 121n and 191a through 191n are initialized after a persistence time, the initialized RFID tags 121a through 121n and 191a through 191n are set to the first target value at the beginning of a next persistence time.

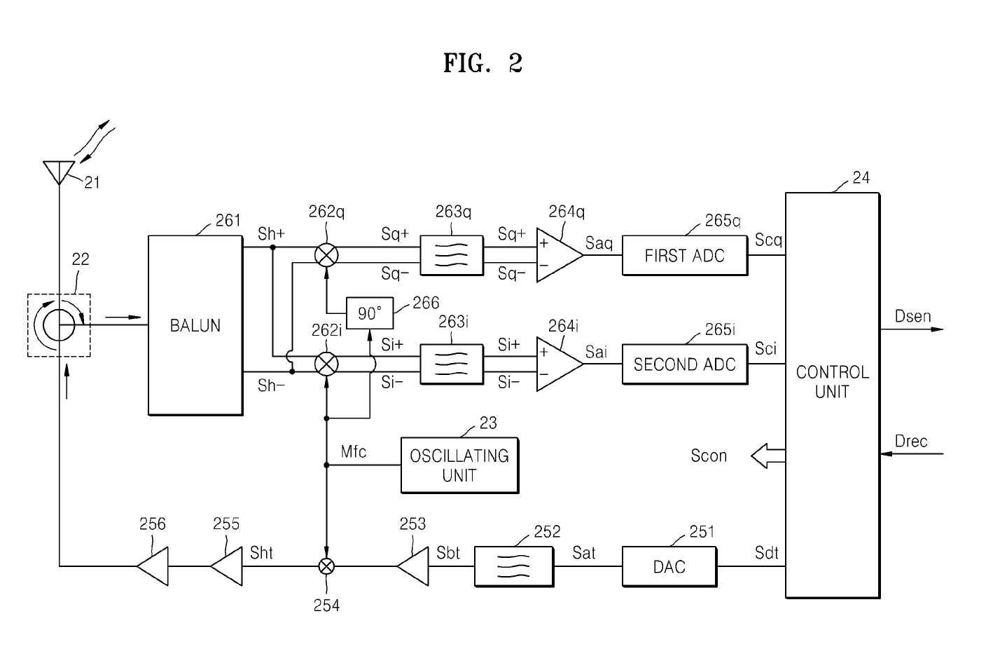

FIG. 2 is a diagram showing an internal configuration of one of the RFID reader readers 111a through 111m of FIG. 1, according to an exemplary embodiment.

Referring to FIG. 2, the RFID reader employing a communication control method according to an exemplary embodiment communicates with RFID tags, and includes transmitting units 251 through 256, 22, and 21, receiving units 261 through 265q, 22, and 21, and a control unit 24.

The transmitting units transmit tag command data Sdt received from the control unit 24 to RFID tags. The receiving units convert signals received from RFID tags to a Q signal Scq and an I signal Sci, which have different phases from each other, and provide the Q signal Scq and the I signal Sci to the control unit 24.

An oscillating unit 23 generates an oscillation signal Mfc having a variable frequency for frequency hopping according to a control signal Scon from the control unit 24. The oscillating unit 23 may be included the transmitting units or the receiving units.

First and second analog-to-digital converters 265q and 265i convert signals Saq and Sai to the digital signals Scq and Sci and input the digital signals Scq and Sci to the control unit 24, respectively.

The control unit 24 generates control signals Scon with respect to various parts of the transmitting units and the receiving units, and transmits the tag command data Sdt and power signals to the RFID tags. Furthermore, the control unit 24 decrypts the digital signals Scq and Sci and transmits the decrypted signals to a server (not shown).

A digital-to-analog converter 251 converts the tag command data Sdt from the control unit 24 to an analog signal Sat. A fundamental frequency filter 252 only transmits a signal of a fundamental frequency to remove noise from the signal Sat transmitted from the digital-to-analog converter 251.

A fundamental frequency amplifier 253 amplifies a signal Sbt from the fundamental frequency filter 252. An up-mixer 254 adjusts the frequency of the signal Sbt from the fundamental frequency amplifier 253 to a currently used radio frequency according to the oscillation signal Mfc having a variable frequency from the oscillating unit 23. In other words, if the frequency of the signal Sbt transmitted from the fundamental frequency amplifier 253 is referred to as fb and the frequency of the oscillation signal Mfc from the oscillating unit 23 is referred to as fm, the frequency ff of a signal Sht transmitted from the up-mixer 254 is calculated as in Equation 1 below.

ff=fb+fm [Equation 1]

In Equation 1 above, the frequency fm of the oscillation signal Mfc from the oscillating unit 23 is calculated as in Equation 2 or Equation 3.

fm=fmp+fn [Equation 2]

fm=fmp−fn [Equation 3]

In Equations 2 and 3 above, a frequency fmp indicates a frequency of the oscillation signal Mfc during a previous period. a frequency fn indicates an interval frequency to be increased or decreased according to an adaptive frequency hopping.

A radio frequency amplifier 255 primarily amplifies power of the signal Sht transmitted from the up-mixer 254. A power amplifier 256 finally amplifies power of the signal Sht transmitted from the radio frequency amplifier 255. The signal Sht transmitted from the power amplifier 256 is transmitted to an RFID tag via a circulator 22 and a transmitting/receiving antenna 21.

Also, a BALUN 261 converts a signal received by the circulator 22 to a first signal Sh+ and a second signal Sh−, which have different phases from each other. In the present embodiment, a phase difference therebetween is 180° (Tr).

A 90° phase shifter 266 shifts a phase of the oscillation signal Mfc from the oscillating unit 23 by 90°.

A Q signal down-mixer 262q converts the first signal Sh+ and the second signal Sh− from the BALUN 261 to a Q+ signal Sq+ and a Q− signal Sq− having a fundamental frequency, according to an oscillation signal from the 90° phase shifter 266.

An I signal down-mixer 262i converts the first signal Sh+ and the second signal Sh− from the BALUN 261 to an I+ signal Si+ and an I− signal Si− having a fundamental frequency, according to the oscillation signal Mfc from the oscillating unit 23.

In other words, if the frequency of the first signal Sh+ and the second signal Sh− from the BALUN 261 is referred to as ff and the frequency of the oscillation signal Mfc from the oscillating unit 23 is referred to as fm, the frequency fb of the Q signals Sq+ and Sq− from the Q signal down-mixer 262q and the I signals Si+ and Si− from the I signal down-mixer 262i is calculated as in Equation 4.

fb=ff−fm [Equation 4]

In Equation 4, the frequency fm of the oscillation signal Mfc from the oscillating unit 23 is calculated as in Equations 2 and 3 above.

A Q signal low-pass filter 263q removes high-frequency noise from the Q+ and Q− signals Sq+ and Sq− from the Q signal down-mixer 262q.

Similarly, an I signal low-pass filter 263i removes high-frequency noise from the I+ and I< signals Si+ and Si− from the I signal down-mixer 262i.

A Q signal differential amplifier 264q generates a Q signal Saq by amplifying a difference between the Q+ and Q− signals Sq+ and Sq− from the Q signal low-pass filter 263q.

Similarly, an I signal differential amplifier 264i generates an I signal Sai by amplifying a difference between the I+ and I− signals Si+ and Si− from the I signal low-pass filter 263i.

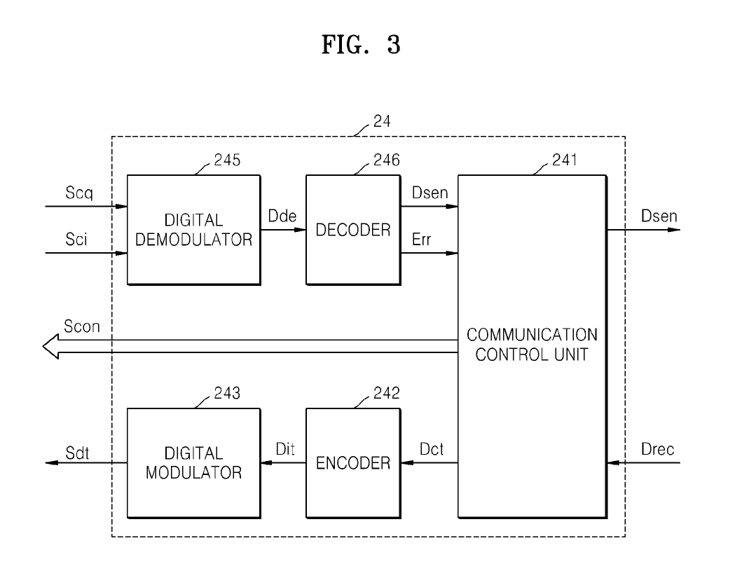

FIG. 3 is a diagram showing the internal configuration of the control unit 24 of FIG. 2, according to an exemplary embodiment.

Referring to FIGS. 2 and 3, the control unit 24 includes a digital demodulator 245, a decoder 246, a communication control unit 241, an encoder 242, and a digital modulator 243.

The digital demodulator 245 generates an integrated digital signal Dde based on the digital Q signal Scq and the digital I signal Sci from the analog-to-digital converters 265q and the 265i, respectively. In detail, the digital demodulator 245 continuously generates positive integrated digital signals or negative digital signals based on the digital Q signal Scq and the digital I signal Sci from the analog-to-digital converters 265q and the 265i.

The decoder 246 continuously generates binary data “1” or “0” by decoding the integrated digital signals continuously input from the digital demodulator 245.

According to a signal Drec from a server, the communication control unit 241 communicates with the server, performs overall controls, and transmits output data Dsen from the decoder 241 to the server.

Here, the communication control unit 241 estimates a persistence time of RFID tags, communicates with the RFID tags during the estimated persistence time, and terminates communication during a set delay time after the persistence time is over.

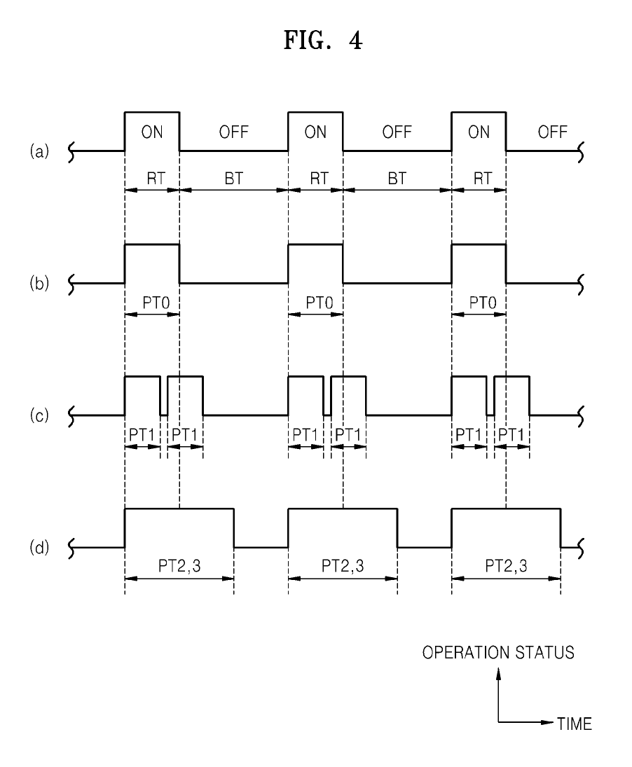

Therefore, if the communication control unit 241 continuously uses a query command of a first target value, the number of RFID tags to be communicated during a communication time gradually decreases, and thus, a possibility of a communication conflict may be decreased. Furthermore, a sufficiently long communication time may be set within a scope in which a possibility of a communication conflict is decreased. Therefore, a possibility of a communication conflict may be effectively decreased. Detailed description thereof will be given below with reference to FIGS. 4 through 14.

The encoder 242 encodes tag command data Dct from the communication control unit 241.

The digital modulator 243 modulates the tag command data Dit from the encoder 242 to digital data, and inputs digital signals Sdt generated via the modulation to the transmitting units.

FIG. 4 illustrates persistence times of the RFID tags of FIG. 1 with respect to a communication period RT and a communication termination period BT of an RFID reader in each session. The communication period RT of an RFID reader refers to a period during which transmitting/receiving units are turned on and perform communication by outputting power signals, so-called “carrier waves.” The communication termination period BT is a period for preventing an RFID reader from being heated and refers to a period during which transmission of power signals is stopped and transmitting/receiving units are turned off.

In FIG. 4, (a) shows communication periods RT and communication termination periods BT of an RFID reader. In FIG. 4, (b) shows persistence times PT0 of RFID tags in the case where session 0 is applied as a communication method. In FIG. 4, (c) shows persistence times PT1 of the RFID tags in the case where session 1 is applied as a communication method. In FIG. 4, (d) shows persistence times PT2 and PT3 of the RFID tags in the case where session 2 or session 3 is applied as a communication method.

Referring to (a) and (b) of FIG. 4, in the case of applying session 0 as the communication method of the RFID reader, the persistence time PTO of the RFID tags is identical to a period of time during which the RFID reader outputs a power signal, that is, the communication time RT. In other words, the persistence time PTO of RFID tags are subordinate to the communication time RT of the RFID reader. Therefore, a communication period RT of the RFID reader cannot be set up, and thus, session 0 is not used in the present invention.

Referring to (a) and (c) of FIG. 4, in the case of applying session 1 as the communication method of the RFID reader, the persistence time PT1 of the RFID tags is terminated regardless of the period of time during which the RFID reader outputs a power signal, that is, the communication time RT.

In the case of applying any of sessions 1 through 3 as the communication method of the RFID reader, if the communication time RT is longer than an unknown persistence time PT1 as shown in FIG. 4C, the RFID tags that accurately communicated with the RFID reader during the first persistence time PT1 become RFID tags to be communicated again during the second persistence time PT1. Therefore, a possibility of a reception conflict may not be effectively decreased.

In the case of applying any of sessions 1 through 3 as the communication method of the RFID reader, if the communication time RT is shorter than an unknown persistence time PT2 or PT3 as shown in FIG. 4D, the number of RFID tags that accurately communicated with the RFID reader during a predetermined period of time is relatively decreased. Therefore, efficiency of communication is deteriorated.

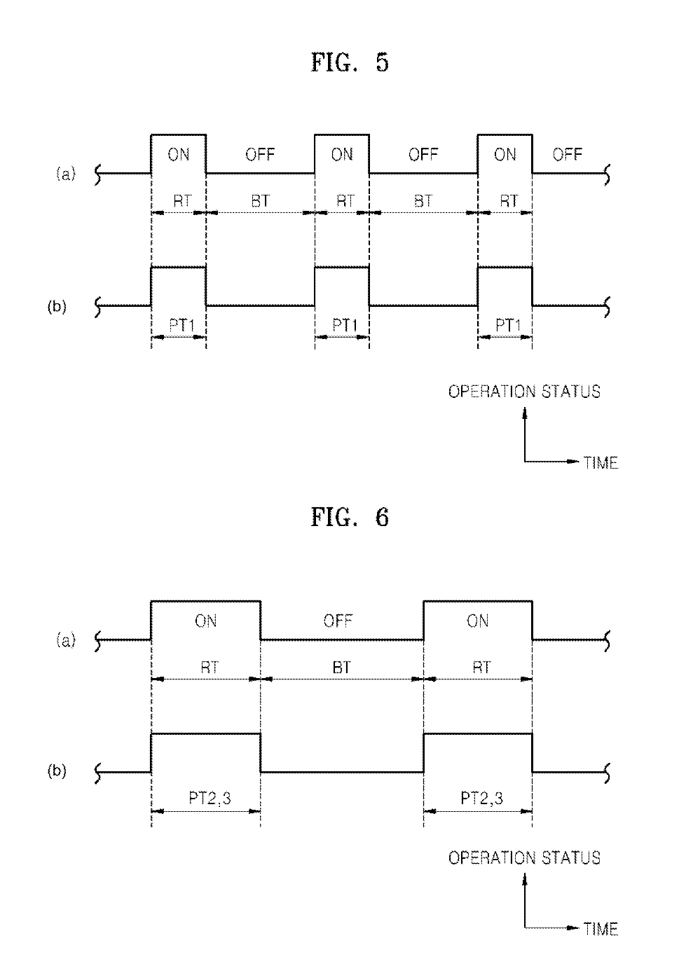

FIG. 5 illustrates communication periods RT and communication termination periods BT in the case of applying session 1 as the communication method of the RFID reader of FIG. 1 employing a communication control method according to an exemplary embodiment.

Specifically, in FIG. 5, (a) shows communication periods RT and communication termination periods BT of the RFID reader employing a communication control method according to an exemplary embodiment. In FIG. 5, (b) shows persistence times PT1 of RFID tags in the case where session 1 is applied as a communication method.

FIG. 6 illustrates communication periods RT and communication termination periods BT in the case of applying session 2 or session 3 as the communication method of the RFID reader of FIG. 1 employing a communication control method according to an exemplary embodiment.

Specifically, in FIG. 6, (a) shows communication periods RT and communication termination periods BT of the RFID reader employing a communication control method according to an exemplary embodiment. In FIG. 6, (d) indicates a persistence time PT2 or PT3 of RFID tags in the case where session 2 or session 3 is applied as a communication method.

Referring to FIGS. 5 and 6, the RFID reader communicates with the RFID tags during the persistence time PT1, PT2, or PT3 of the RFID tags and terminates communication during a set delay time BT after the persistence time PT1, PT2, or PT3 is over.

Therefore, if the RFID reader continuously uses a query command of a first target value, the number of RFID tags to be communicated during a communication time gradually decreases, and thus, a possibility of a communication conflict may be decreased with the lapse of the communication time RT. Furthermore, a sufficiently long communication time may be set within a scope in which a possibility of a communication conflict is decreased. Therefore, a possibility of a communication conflict may be effectively decreased.

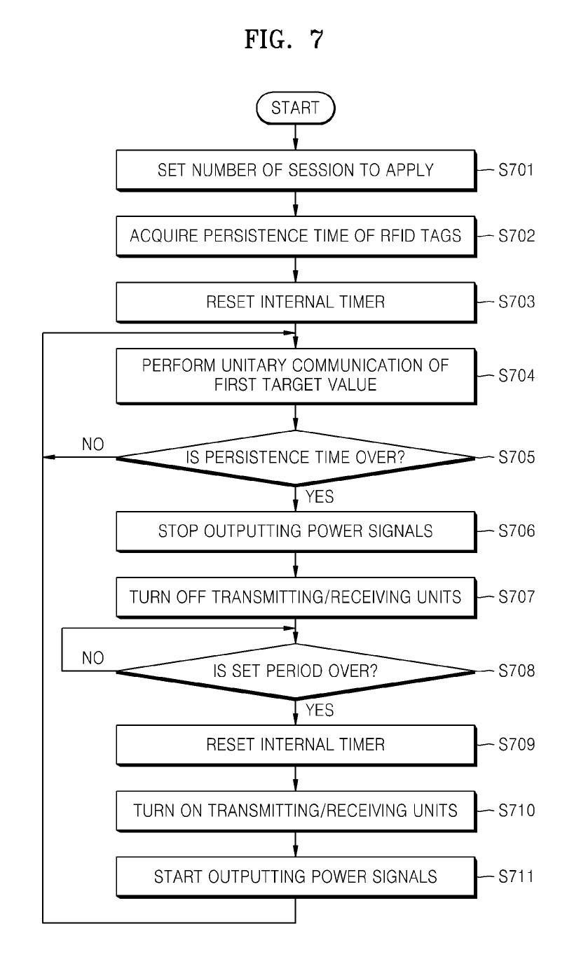

FIG. 7 is a flowchart showing a communication control method performed by the communication control unit 241 of FIG. 3, according to an exemplary embodiment. Referring to FIGS. 7 and 3, the communication control method performed by the communication control unit 241 will be described below.

In operation S701, the communication control unit 241 sets a number of session to be applied as a communication session. In other words, any of sessions 1 through 3 in which RFID tags are initialized after a persistence time is set.

In operation S702, the communication control unit 241 acquires a persistence time by communicating with RFID tags.

In operation S703, the communication control unit 241 resets an internal timer.

In operations S704 through S711, the communication control unit 241 repeatedly performs communication with the RFID tags during a calculated persistence time and termination of communication during a set delay time after the calculated persistence time is over.

In detail, the communication control unit 241 performs unitary communication of a first target value (S703). In other words, the communication control unit 241 transmits a query command to the RFID tags and receives tag information of one of the RFID tags responding to the query command. Operation S704 is repeatedly performed unit the persistence time is over (S705).

After the persistence time is over, the communication control unit 241 stops outputting a power signal (S706), turns off transmitting/receiving units (S707), and stands by until a set period (RT+BT in FIGS. 5 and 6) (S708) is over.

Next, the communication control unit 241 resets an internal timer (S709), turns on the transmitting/receiving units (S710), starts to output a power signal (S711), and repeats operations from operation S704 stated above.

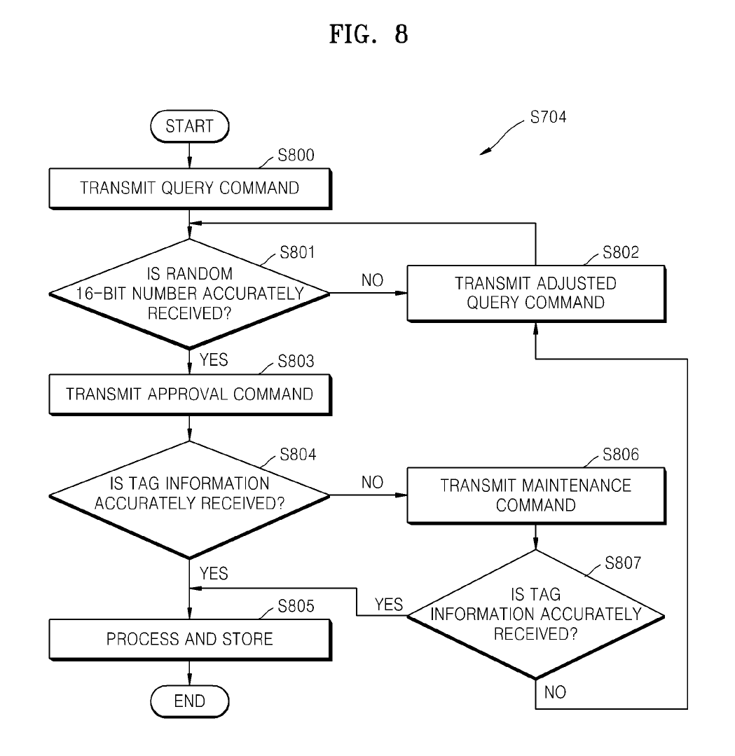

FIG. 8 is a flowchart showing operation S704 in detail.

Referring to FIGS. 8 and 3, operation S704 will be described below in detail.

First, the communication control unit 241 transmits a query command to the RFID tags (S800).

Here, the RFID tags, which have received the query command, transmit random 16-bit numbers to the RFID reader. Accordingly, the communication control unit 241 determines whether a random 16-bit number from one of the RFID tags is accurately received (S801).

If a random 16-bit number from an RFID tag is not accurately received, the communication control unit 241 transmits an adjusted query command (S802). The adjusted query command refers to data acquired by adding or subtracting binary value “1” to or from the previously transmitted query command data.

If a random 16-bit number from an RFID tag is accurately received, the communication control unit 241 transmits an approval command to the RFID tag (S803). Therefore, the RFID tag transmits tag information thereof to the RFID reader.

Next, the communication control unit 241 determines whether the tag information is accurately received (S804).

If the tag information is not accurately received, the communication control unit 241 transmits a maintenance command to the RFID tag (S806). Therefore, the RFID tag maintains transmission of the tag information. If the tag information is not accurately received even after the maintenance command is transmitted, operations from operation S802 stated above are repeatedly performed (S807).

Otherwise, if the tag information is accurately received, the communication control unit 241 processes and stores the tag information (S805).

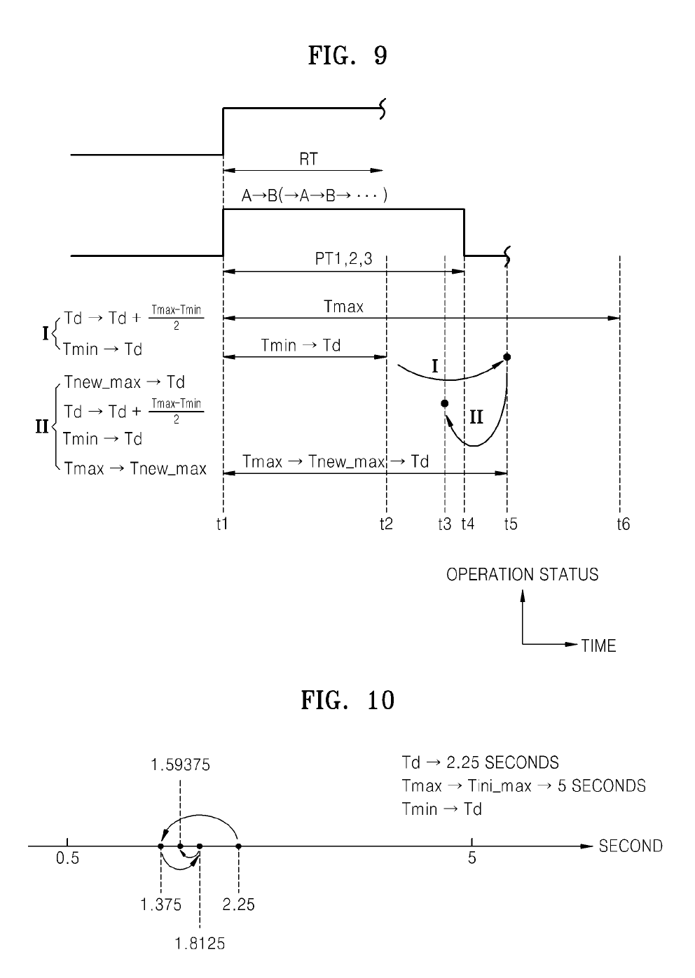

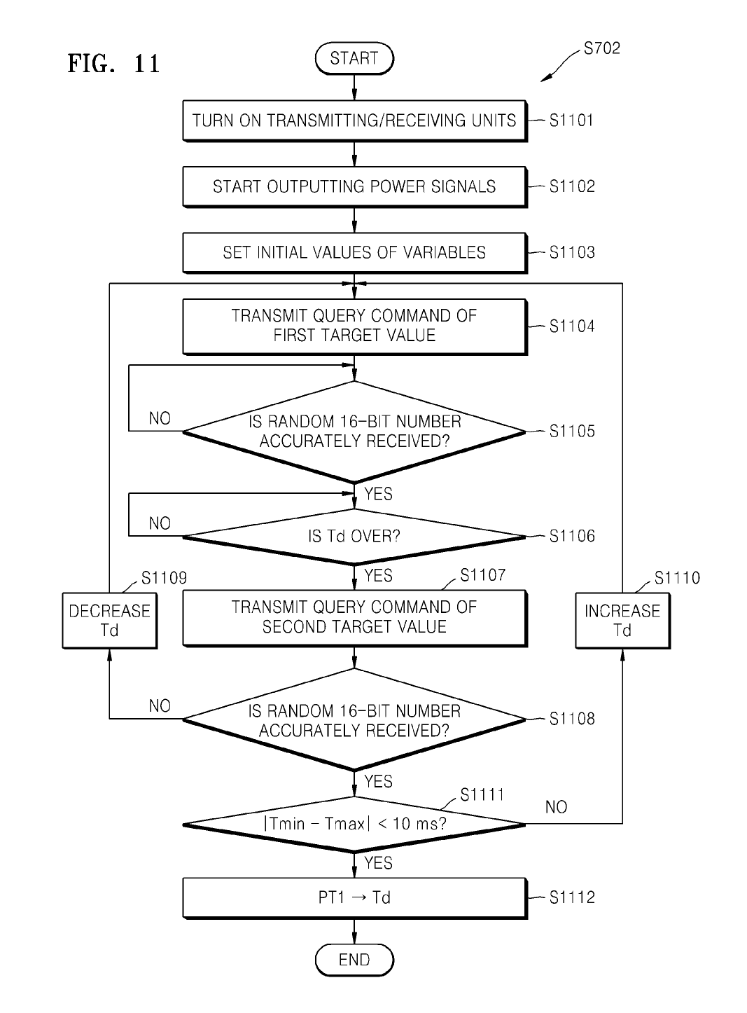

FIG. 9 is a diagram for describing operation S702 of FIG. 7. FIG. 10 is a diagram showing an example of a method of calculating a persistence time shown in FIG. 9 in the case where session 1 is applied to the RFID reader of FIG. 1. FIG. 11 is a flowchart showing details of operation S702 in the case where session 1 is applied to the RFID reader of FIG. 1.

Referring to FIGS. 9 through 11, operation S702 will be described below in detail.

First, a communication control unit (241 of FIG. 3) turns on transmitting/receiving units (S1101), starts outputting power signals (S1102), and initializes RFID tags.

Next, the communication control unit 241 sets up initial values of variables for calculating a persistence time (S1103). Here, initial values of a minimum time Tmin, a maximum time Tmax, a delay time Td, and an initial maximum time Tini_max are set.

For example, the delay time Td is set to 2.25 seconds, the minimum time Tmin is set to 2.25 seconds, the maximum time Tmax is set to 5 seconds, and the initial maximum time Tini_max is set to 5 seconds (refer to FIG. 10).

Next, the communication control unit 241 transmits a query command of a first target value to RFID tags (S1104).

In operations S1105 and S1106, if communication is accurately performed with one of the RFID tags corresponding to the first target value, the communication control unit 241 stands by during the delay time Td. In other words, if a random 16-bit number is accurately received from one of the RFID tags corresponding to the first target value, the communication control unit 241 stands by during the delay time Td.

In operation S1106, when the delay time Td is over, the communication control unit 241 transmits a query command of a second target value to the RFID tags (S1107).

In operations S1108 through S1112, if communication is accurately performed with one of the RFID tags corresponding to the second target value, the delay time TD is increased. Otherwise, the delay time Td is decreased and a persistence time PT1 of the RFID tags is estimated. In other words, if a random 16-bit number is accurately received from one of the RFID tags corresponding to the second target value, the delay time TD is increased. Otherwise, the delay time Td is decreased and the persistence time PT1 of the RFID tags is estimated

Here, the minimum time Tmin, the maximum time Tmax, and the delay time Td are used as variables (refer to FIGS. 9 and 10).

The delay time Td is increased or decreased by a half of a difference between the minimum time Tmin and the maximum time Tmax, that is, (Tmax−Tmin)/2.

Furthermore, whenever the delay time Td is changed, the minimum time Tmin is changed, such that the changed delay time Td is identical to the minimum time Tmin (Tmin→Td).

Furthermore, the delay time Td corresponding to a time point at which the difference between the minimum time Tmin and the maximum time Tmax|Tmin−Tmax| is shorter than a reference time, e.g., 10 milliseconds (ms), is determined as the persistence time PT1 of the RFID tags (S1111 and S1112).

In detail, if communication is not accurately performed with one of the RFID tags corresponding to the second target value in operation S1108, it means that all of the RFID tags are newly initialized, and thus, operation S1108 is performed to reduce the delay time Td and operations S1104 through S1107 are performed again. In other words, if a random 16-bit number is not accurately received from the RFID tag of the second target value, it means that all of the RFID tags are newly initialized, and thus, operation S1108 is performed to reduce the delay time Td and operations S1104 through S1107 are performed again.

Otherwise, if communication is accurately performed with one of the RFID tags corresponding to the second target value in operation S1105, it means that all of the RFID tags are not yet newly initialized, and thus, it is determined whether the difference between the minimum time Tmin and the maximum time Tmax|Tmin−Tmax| is shorter than a reference time, e.g., 10 milliseconds (ms) (S1111). In other words, if a random 16-bit number is not accurately received from the RFID tag of the second target value, it means that all of the RFID tags are not yet newly initialized, and thus, it is determined whether the difference between the minimum time Tmin and the maximum time Tmax|Tmin−Tmax| is shorter than a reference time, e.g., 10 milliseconds (ms) (S1111).

If the difference between the minimum time Tmin and the maximum time Tmax|Tmin−Tmax| is not shorter than the reference time, operation S1110 is performed to increase the delay time Td and operations S1104 through S1108 are performed again.

In operation S1111, if the difference between the minimum time Tmin and the maximum time Tmax|Tmin−Tmax| is shorter than the reference time, the delay time Td is determined as the persistence time PT1 of the RFID tags (S1112).

In operation S1109, a new maximum time Tnew_max is accessorily used as a variable for decreasing the delay time Td. The decrease of the delay time Td in operation S1109 will be described in detail below (refer to II of FIG. 9).

First, the new maximum time Tnew_max is set, such that the delay time Td and the new maximum time Tnew_max are identical to each other (period of time t1 through t5 in FIG. 9).

After the new maximum time Tnew_max is set, the delay time Td is decreased by a half of a difference between the minimum time Tmin and the maximum time Tmax, that is, (Tmax−Tmin)/2.

After the delay time Td is decreased, the minimum time Tmin is changed such that the decreased delay time Td and the minimum time Tmin are identical to each other (Tmin→Td).

After the minimum time Tmin is changed, the maximum time Tmax is changed, such that the new maximum time Tnew_max and the maximum time Tmax are identical to each other.

The increase of the delay time Td in operation S1110 will be described in detail below (refer to I of FIG. 9).

First, the delay time Td is increased by a half of a difference between the minimum time Tmin and the maximum time Tmax, that is, (Tmax−Tmin)/2.

After the delay time Td is increased, the minimum time Tmin is changed such that the decreased delay time Td and the minimum time Tmin are identical to each other.

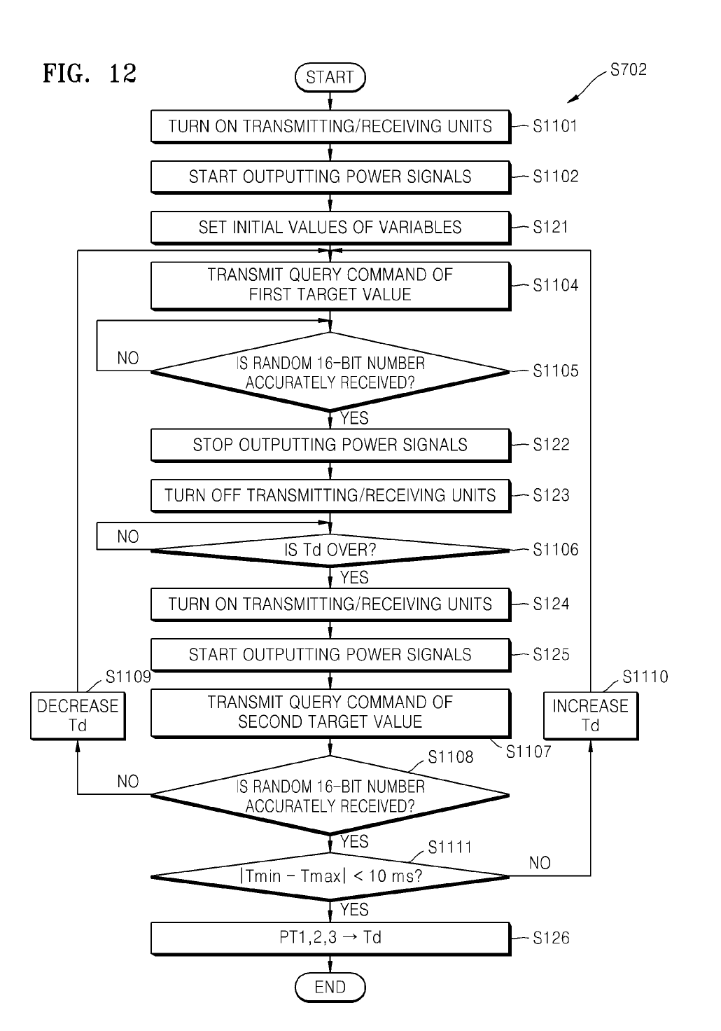

FIG. 12 is a diagram showing an example of operations S702 in the case of applying any of sessions 1 through 3 to the RFID reader of FIG. 1. In FIGS. 11 and 12, like operation numbers indicate like operations.

As described above, if session 2 or session 3 is applied as a communication method of the RFID reader, the persistence time of RFID tags is terminated during the communication termination period BT of the RFID reader (refer to FIG. 4).

Therefore, differences between the embodiment shown in FIG. 11 and the embodiment shown in FIG. 12 are as follows.

First, in operations S1105 and S1106 of FIG. 11, if communication is accurately performed with one of the RFID tags corresponding to the first target value, output of power signals is stopped and the delay time Td is awaited.

Second, after the delay time Td is over in operations S1106 and S1107, power signals are output again and query command of the second target value are transmitted to the RFID tags.

Referring to FIGS. 9, 10, and 12, operation S702 of FIG. 7 in the case of applying any of sessions 1 through 3 will be described below in detail.

First, a communication control unit (241 of FIG. 3) turns on transmitting/receiving units (S1101), starts outputting power signals (S1102), and initializes RFID tags.

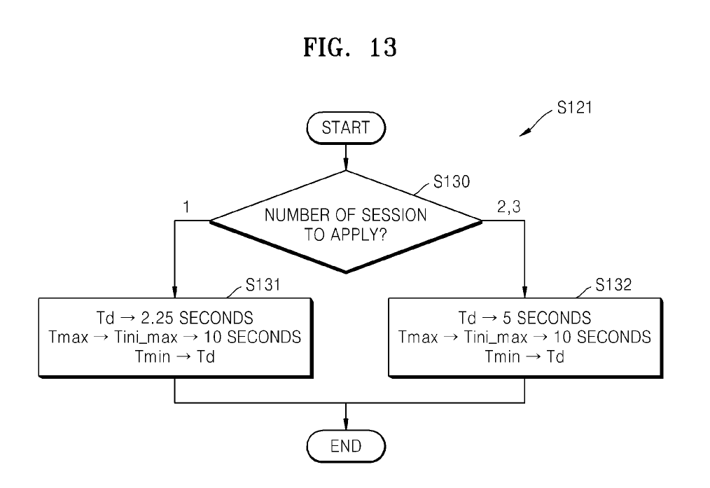

Next, the communication control unit 241 sets initial values of variables for calculating a persistence time (S121). Here, it is necessary to designate different values as initial values of a minimum time Tmin, a maximum time Tmax, a delay time Td, and an initial maximum time Tini_max in the case of applying session 1 and in the case of applying session 2 or session 3 because the persistence time PT2 or PT3 in case of session 2 or session 3 is longer than the persistence time PT1 of session 1. An example thereof will be described below with reference to FIG. 13.

Next, the communication control unit 241 transmits a query command of a first target value to RFID tags (S1104).

In operation S1105, if communication is accurately performed with one of the RFID tags corresponding to the first target value, the communication control unit 241 stops outputting power signals (so-called carrier waves) (S122) and turns off the transmitting/receiving units (S123). In other words, if a random 16-bit number is accurately received from one of the RFID tags corresponding to the first target value (S1105), the communication control unit 241 stops outputting power signals (so-called carrier waves) (S122) and turns off the transmitting/receiving units (S123).

Next, the communication control unit 241 stands by during the delay time Td (S1106).

In operation S1106, when the delay time Td is over, the communication control unit 241 turns on the transmitting/receiving units (S124) and starts outputting power signals (S125).

Next, the communication control unit 241 transmits a query command of a second target value to the RFID tags (S1107).

In operations S1108 through S1112, if communication is accurately performed with one of the RFID tags corresponding to the second target value, the delay time TD is increased. Otherwise, the delay time Td is decreased and persistence times PT1, 2, 3 of the RFID tags are estimated. In other words, if a random 16-bit number is accurately received from one of the RFID tags corresponding to the second target value, the delay time TD is increased. Otherwise, the delay time Td is decreased and the persistence time PT1, 2, 3 of the RFID tags are estimated.

The detailed algorithms of operations S1108 through S1111 are as described above with reference to FIGS. 9 through 11.

Next, the delay time Td corresponding to a time point at which the difference between the minimum time Tmin and the maximum time Tmax|Tmin−Tmax| is shorter than a reference time, e.g., 10 milliseconds (ms), is determined as the persistence time PT1, 2, 3 of the RFID tags (S1111 and S126).

FIG. 13 is a diagram showing operation S121 of FIG. 12 in detail.

As described above, the persistence time PT1, 2, 3 in the case of applying session 2 or session 3 is greater than a persistence time in the case of applying session 1. Therefore, initial values in the case of applying session 2 or session 3 are greater than those in the case of applying session 1.

For example, in the case of applying session 1, the delay time Td is set to 2.25 seconds, the minimum time Tmin is set to 2.25 seconds, the maximum time Tmax is set to 5 seconds, and the initial maximum time Tini_max is set to 5 seconds (refer to FIG. 10).

In the case of applying session 2 or session 3, the delay time Td is set to 5 seconds, the minimum time Tmin is set to 5 seconds, the maximum time Tmax is set to 10 seconds, and the initial maximum time Tini_max is set to 10 seconds.

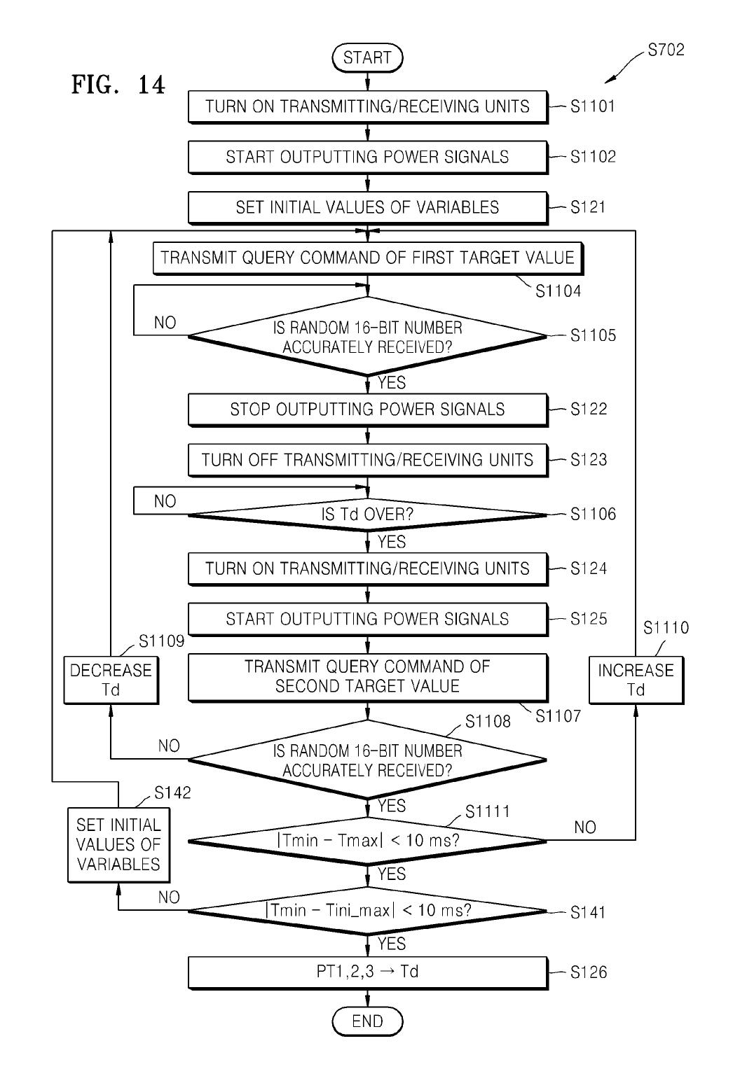

However, it may be difficult to determine a session to apply and set different initial values according to the session in operations S121 of FIG. 12. Therefore, in the embodiment shown in FIG. 14, only initial values with respect to session 1 are set in operation S121 of FIG. 12, and, if a persistence time calculated in operation S111 of FIG. 12 is not suitable for session 2 or session 3, initial values of variables are adjusted.

FIG. 14 is a diagram showing another example of operations S702 in the case of applying any of sessions 1 through 3 to the RFID reader of FIG. 1.

In FIGS. 12 and 14, like operation numbers indicate like operations. However, although initial values are selectively set based on a session to apply in operation S121 in the embodiment shown in FIG. 12, only initial values with respect to session 1 are set in operation S121 in the embodiment shown in FIG. 14.

For example, the delay time Td is set to 2.25 seconds, the minimum time Tmin is set to 2.25 seconds, the maximum time Tmax is set to 5 seconds, and the initial maximum time Tini_max is set to 5 seconds.

The difference between the embodiment shown in FIG. 12 and the embodiment shown in FIG. 14 is that the embodiment shown in FIG. 14 further includes operations S141 and S142. Therefore, only descriptions of operations S141 and S142 will be given below.

In operation S1111, if the difference between the minimum time Tmin and the maximum time Tmax|Tmin−Tmax| is shorter than a reference time, e.g., 10 milliseconds (ms), a communication control unit (241 of FIG. 3) determines whether the difference between the minimum time Tmin and the initial maximum time Tini_max is not shorter than the reference time (S141).

If the difference between the minimum time Tmin and the initial maximum time Tini_max is not shorter than the reference time, it means that a communication method corresponds to session 1, and thus, the communication control unit 241 determines the delay time Td as the persistence time PT1, 2, 3 (S126).

Otherwise, if the difference between the minimum time Tmin and the initial maximum time Tini_max is shorter than the reference time, it means that a communication method corresponds to session 2 or session 3, and thus the communication control unit 241 does not determine the delay time Td as the persistence times PT1, 2, 3. Therefore, the communication control unit 241 repeats operations from operation S1104 after initial values of variables are adjusted (S142).

For example, if the delay time Td is set to 2.25 seconds, the minimum time Tmin is set to 2.25 seconds, the maximum time Tmax is set to 5 seconds, and the initial maximum time Tini_max is set to 5 seconds in operation S121, initial values of the variables are adjusted in operation S1109 as follows:

The minimum time Tmin is adjusted to be identical to the initial maximum time Tini_max, that is, 5 seconds.

Next, the delay time Td is adjusted to be identical to the minimum time Tmin, that is, 5 seconds.

Next, the maximum time Tmax is adjusted to be twice of the minimum time Tmin, that is, 10 seconds.

Next, the initial maximum time Tini_max is set to be identical to the maximum time Tmax, that is, 10 seconds.

As described above, according to a communication control method for an RFID reader according to the exemplary embodiments, the RFID reader communicates with RFID tags during a persistence time of RFID tags, and terminates communication during a set delay time after the persistence time is over.

Therefore, if the RFID reader continuously uses a query command of a first target value, the number of RFID tags to be communicated during a communication time gradually decreases, and thus, a possibility of a communication conflict may be decreased with the lapse of the communication time RT. Furthermore, a sufficiently long communication time may be set within a scope in which a possibility of a communication conflict is decreased. Therefore, a possibility of a communication conflict may be effectively decreased.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims.

1. A communication control method for a Radio Frequency identification (RFID) reader, which communicates with a plurality of RFID tags, the communication control method comprising:
(a) setting a session in which the RFID tags are initialized after a persistence time;
(b) communicating with the RFID tags during the persistence time of the RFID tags; and
(c) terminating communications during a set delay time after the persistence time of the RFID tags is over.

2. The communication control method of claim 1, wherein operations (b) and (c) are performed at least one time.

3. The communication control method of claim 1, wherein, in operation (b),
the RFID reader communicates with the RFID tags and calculates the persistence time of the RFID tags.

4. The communication control method of claim 3, wherein, in operation (b), when the RFID reader transmits a query command of a first target value to the RFID tags, one of the RFID tags set to the first target value accurately communicates with the RFID reader and is set to a second target value,
wherein when the RFID reader transmits a query command of the second target value to the RFID tags, one of the RFID tags set to the second target value accurately communicates with the RFID reader and is set to the first target value, and
wherein after the RFID tags are initialized after the persistence time, the initialized RFID tags are set to the first target value at the beginning of a next persistence time.

5. The communication control method of claim 4, wherein operation (b) comprises:
(b1) starting outputting power signals and initializing the RFID tags;
(b2) transmitting the query command of the first target value to the RFID tags;
(b3) if communication is accurately performed with one of the RFID tags set to the first target value, standing by during a delay time;
(b4) after the delay time is over in operation (b3), transmitting the query command of the second target value to the RFID tags; and
(b5) increasing the delay time if communication is accurately performed with one of the RFID tags set to the first target value, and decreasing the delay time and estimating persistence time of the RFID tags if communication is not accurately performed with one of the RFID tags set to the first target value.

6. The communication control method of claim 5, wherein, in operation (b5), a minimum time, a maximum time, and the delay time are used as variables,
wherein the delay time is increased or decreased based on a difference between the minimum time and the maximum time,
wherein when the delay time is changed, the minimum time is changed, such that the changed delay time is identical to the minimum time, and
wherein the delay time corresponding to a time point at which the difference between the minimum time and the maximum time is shorter than a reference time is determined as the persistence time of the RFID tags.

7. The communication control method of claim 6, wherein, in operation (b5), the delay time is increased or decreased by a half of the difference between the minimum time and the maximum time.

8. The communication control method of claim 7, wherein operation (b5) comprises:
(b51) if a communication is not accurately performed with the RFID tags set to the second target value in operation (b3), decreasing the delay time and performing operations (b2) through (b4);
(b52) if a communication is accurately performed with the RFID tags set to the second target value in operation (b3), determining whether the difference between the minimum time and the maximum time is shorter than the reference time;
(b53) if the difference between the minimum time and the maximum time is not shorter than the reference time, increasing the delay time and performing operations (b2) through (b4); and
(b54) if the difference between the minimum time and the maximum time is shorter than the reference time, determining the delay time as the persistence time of the RFID tags.

9. The communication control method of claim 8, wherein, when the delay time is decreased in operation (b51), a new maximum time is used as another variable,
wherein the new maximum time is set, such that the delay time and the new maximum time are identical to each other;
wherein after the new maximum time is set, the delay time is decreased by a half of the difference between the minimum time and the maximum time;
wherein after the delay time is decreased, the minimum time is changed, such that the decreased delay time and the minimum time are identical to each other; and
wherein after the minimum time is changed, the maximum time is changed, such that the new maximum time and the maximum time are identical to each other.

10. The communication control method of claim 9, wherein, when the delay time is increased in operation (b53), the delay time is increased by a half of the difference between the minimum time and the maximum time, and
wherein after the delay time is increased, the minimum time is changed, such that the increased delay time and the minimum time are identical to each other.

11. The communication control method of claim 5, wherein, if communication is accurately performed with one of the RFID tags set to the first target value, a delay time is awaited, and
wherein after the delay time is over in operation (b4), power signals are output again and the query command of the second target value are transmitted to the RFID tags.

12. The communication control method of claim 8, wherein, in operation (b5), the initial maximum time is used as another variable, and
wherein the delay time is determined as the persistence time if the difference between the minimum time and the initial maximum time is not shorter than the reference time in operation (b54).

13. The communication control method of claim 12, wherein, in operation (b5), if the difference between the minimum time and the initial maximum time is shorter than the reference time and the difference between the minimum time and the maximum time is shorter than the reference time, operations (b51) through (b54) are performed again after initial values of variables are adjusted.
